(19) United States
(12) Patent Application Publication
(10) Pub. No.: US 2025/0167606 A1
(43) Pub. Date: May 22, 2025

(54) ELECTRIC MOTOR

(71) Applicant: ELDOR CORPORATION S.P.A., Orsenigo (Como) (IT)

(72) Inventors: Pasquale FORTE, Orsenigo (Como) (IT); Ruggero SECCIA, Orsenigo (Como) (IT); Luca ZAI, Orsenigo (Como) (IT)

(21) Appl. No.: 18/708,926

(22) PCT Filed: Nov. 9, 2022
(86) PCT No.: PCT/IB2022/060786

§ 371 Date: May 9, 2024

(30) Foreign Application Priority Data
Nov. 10, 2021 (IT) 102021000028502

(51) Int. Cl. H02K 1/22; H02K 1/2706; H02K 3/28; H02K 3/34; H02K 11/20

(52) U.S. Cl. CPC H02K 1/223; H02K 1/2706; H02K 3/28; H02K 3/345; H02K 11/20

(57) ABSTRACT

An electric motor includes a stator, a rotor, a plurality of magnets, and a plurality of windings. The stator is provided with a casing extending along a main axis between two end faces inside of which the rotor is inserted. The rotor is rotatable around the main axis and has a plurality of first slots inside of which the permanent magnets are inserted and a plurality of second slots that are radially internal in relation to the first slots and to which the windings are coupled. In addition, the first slots are grouped in a plurality of first groups wherein each first slot defines a corresponding section of a segmented profile.

This invention relates to the technical filed of electric drive systems.

In particular, this invention concerns an electric motor that may be advantageously, and without limitations, used in the automotive sector for the design and manufacture of electric or hybrid propulsion vehicles.

Prior art motors involve the rotor's being produced so as to comprise a plurality of magnetic poles defined using permanent magnets or a series of windings made of conductive material that generate a specific magnetic field when an electric current passes through them.

In any case, the known solutions are, in the current state, still affected by drawbacks that make their dissemination on the market difficult, in particular since obtaining good performance is strictly linked to relatively high costs and complexity.

In fact, if you wish to obtain acceptable performance levels by using magnets for the creation of rotor poles, it is necessary to use materials, specifically rare-earth elements, which are extremely costly and difficult to obtain.

Alternatively, in general, it would be possible to use more cost-effective magnets (for example made of ferrite), which are, however, less effective and easy to demagnetise, significantly reducing the service life of the rotor and providing, thus, a solution that is not very satisfactory.

If, instead, the poles are defined by windings (or similar structures/elements), it is possible to manufacture high-performing motors that cannot, however, sustain such performance continuously, since the generation of the magnetic field by the rotor using the current flowing in the windings generates a contemporaneous heating that cannot be sustained over extended periods.

In addition, the high current values needed for the correct operation of the motor require the presence of a considerably sized system for powering the rotor, thus increasing the bulk and complexity of the motor.

In this same context, the overall efficiency is also proportional to the number of windings installed, which must also be large enough to enable a minimum level of thermal disposal, thus creating issues of mechanical strength since the greater volumes and bulk generated by the windings make it more difficult to resist the centrifugal effect for high rotor revolutions.

It is, thus, clear that, in the sector, there is a strong need to develop new solutions able to facilitate the production of motors with high performance without this entailing, necessarily, an excessive and unreasonable increase in costs and manufacturing complexity.

In this context, the technical task underlying this invention is to propose an electric motor that overcomes at least some of the drawbacks of the prior art cited above.

In particular, it is the purpose of this invention to provide an electric motor with high performance.

The specified technical task and purposes are substantially achieved by means of an electric motor comprising the technical features set forth in one or more of the accompanying claims.

An electric motor is shown according to this invention.

The electric motor basically comprises a stator, a rotor, a plurality of permanent magnets, and a plurality of windings.

The stator is provided with a casing, which extends along a main axis between two end faces.

The rotor is inserted inside the casing and rotates around the main axis.

In addition, the rotor is preferably of the interior permanent magnet (IPM) type, thus not of the salient pole type.

In this respect, the rotor preferably has a plurality of first slots and a plurality of second slots, wherein the second slots are radially internal to the first slots.

Inside the first slots, corresponding permanent magnets are inserted.

The second slots are, instead, coupled to the windings.

The motor preferably, additionally comprises a dedicated power device configured to supply electric power to the windings.

In addition, the first slots are grouped so as to define a plurality of first groups wherein each first slot of the same first group defines a corresponding section of a segmented profile.

The segmented profile is preferably, basically “U” or “V” shaped.

In particular, the “U” or “V” shaped profile is arranged so as to have a base turned towards the main axis.

The second slots are also, preferably grouped so as to define a plurality of second groups wherein each second slot of the same second group defines a corresponding section of a segmented profile.

The segmented profile is, preferably, basically “U” or “V” shaped in this case too.

In particular, the “U” or “V” shaped profile is arranged so as to have a base turned towards the main axis.

Advantageously, the motor presented and described here makes it possible to reduce the overall volume of the permanent magnets needed for its operation, ensuring, at the same time, optimal performance thanks to the contemporaneous presence of magnets and windings.

In addition, the possibility of autonomously controlling, thanks to the dedicated power device, the operation of the windings makes it possible to manage more precisely the thermal behaviour of the motor and its overall operation, as well as to completely switch it off in the event of a breakdown.

The dependent claims, incorporated herein for reference, correspond to different embodiments of the invention.

Additional features and advantages of this invention will be clearer from the indicative, and therefore non-limiting, description of one preferred, but not exclusive, embodiment of an electric motor, as illustrated in the attached drawings wherein:

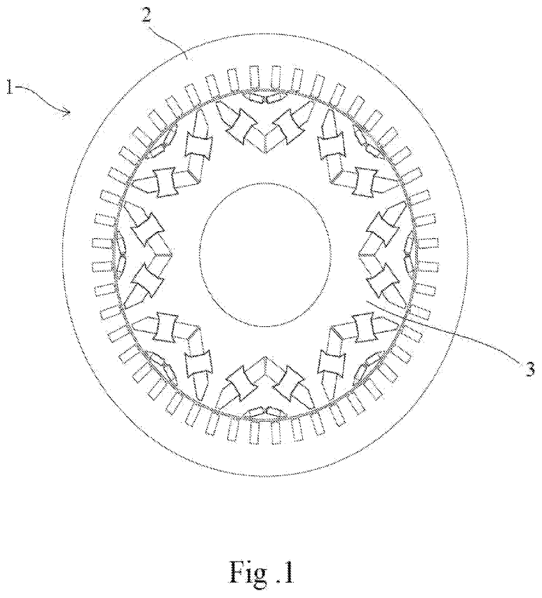

FIG. 1 shows a view of the rotor according to this invention;

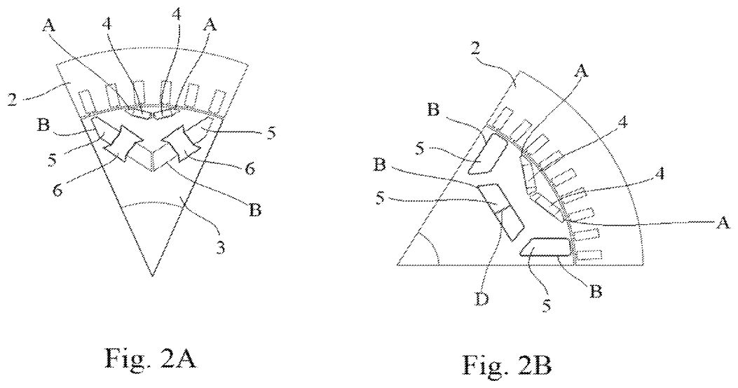

FIG. 2A depicts a detail in FIG. 1;

FIG. 2B depicts a detail of the motor manufactured in accordance with a possible, alternative embodiment.

In the attached figures, reference number 1 generically indicates an electric motor, indicated below in this description simply as the motor 1.

In particular, this motor 1 may be the motor of an electric or hybrid propulsion vehicle without, however, excluding motors suitable for use in other sectors because of this.

From a structural point of view, the motor 1 basically comprises a stator 2, a rotor 3, a plurality of magnets 4, and a plurality of windings 5.

The stator 2 is provided with a casing extending along a main axis between two end faces and operationally defines a cylindrical cavity inside of which the rotor 3 may be housed.

The rotor 3 is, thus, inserted inside the casing so as to rotate, in use, around the main axis.

The rotor 3 is preferably of the interior permanent magnets (IPM) type, thus not of the salient pole type.

In this respect, the rotor 3 preferably has, in addition, a plurality of slots extending from one end to the other of the rotor 4 along directions basically parallel to the main axis.

In more detail, the slots are divided into two separate groups, specifically defining a plurality of first slots A and a plurality of second slots B, which are arranged on the rotor 3 so as to be radially internal to the first slots A.

In addition, the first slots A are grouped together, preferably so as to define a plurality of first groups in which, on a plane perpendicular to the main axis, each first slot A defines a corresponding section of a segmented. preferably “U” or “V” shaped profile, which has a base turned towards the main axis.

In other words, the first slots A may be positioned and arranged on the rotor 3 so as to be coupled in twos and each first slot A is appropriately tilted so as to define, together with the additional first slot A coupled to it, a “V” that has its base (or the V's vertex) facing the main axis and the opening arranged towards the outside and, thus, facing the stator 2.

Alternatively, the first slots A may be positioned and arranged on the rotor 3 in groups of three and each first slot A is appropriately tilted so as to define, together with the other two first slots A coupled to it, a “U” that has its base facing the main axis and the opening arranged towards the outside and, thus, facing the stator 2.

In general, the first slots A belonging to the same group are oriented and arranged in a predefined order contributing to creating the corresponding segmented profile.

The first slots A, though grouped together, are preferably separated and distinct between them, i.e., there is a partition placed between the first slots A that are part of the same group and that keeps these first slots A separate from each other.

In particular, if the first slots are arranged according to a “V” shaped profile, the partition is positioned at the vertex of this profile.

In accordance with one preferred embodiment, the second slots B are also grouped together so as to define a plurality of second groups in which, again on a plane perpendicular to the main axis, each second slot B defines a corresponding section of a segmented profile, preferably a basically “U” or “V” shaped profile, which has a base turned towards the main axis.

Similarly to what was indicated for the first slots A, the second slots B of each group are also preferably kept separate and distinct using a partition placed between the two.

Therefore, in general, the first slots A define a first circular crown arranged around the main axis while the second slots B define a second circular crown radially internal to the first and each circular crown is formed, respectively, of groups of first slots A and second slots B facing each other.

The number of groups of first slots A is preferably equal to the number of groups of second slots B so as to define an equal number of groups in which each group of first slots A is radially aligned with a corresponding group of second slots.

Still more preferably, the number of first slots A is equal to the number of second slots B and the groups of first and second slots A, B define the same profile.

By way of example, if a “V” shaped profile is made, the profiles defined by the first and second slots A, B are positioned with the vertices defined by the first slots A directly facing and directed towards corresponding openings delineated and defined by the second slots B.

In other words, the first slots A and the second slots B define, in this specific context, corresponding multiple “V” shaped profiles arranged circumferentially around the main axis with the second slots B radially inside and aligned in relation to the first slots A.

This double “V” configuration offers the advantage of having greater resistance to the centrifugal force to which the rotor 3 is subject during the operation of the motor 1, improving the stability and durability thereof.

Inside the first slots A and the second slots B, the permanent magnets 4 and the windings 5 are inserted respectively.

Thus, inside each first slot A a corresponding permanent magnet 4 is housed.

The grouping of the first slots A and their specific arrangement according to a segmented profile ensures that the profile of the magnetic field generated by the permanent magnets 4 is optimal for the operation of the motor 1, also reducing the overall dimensions of the permanent magnets 4 compared to the known devices.

In other words, the specific arrangement and orientation of the first slots A make it possible to obtain high performance, even with a combination of permanent magnets 4 of reduced size, avoiding, thus, the need to use large quantities of expensive materials that are difficult to obtain to optimise the overall operation of the motor 1.

Similarly, the second slots B are, instead, coupled to the windings 5 that are specifically manufactured using one of the methods that will be explored below.

The joint presence of magnets and windings 5 makes it possible to ensure excellent performance of the motor 1 without needing to oversize the power supply system and without the risk of an excessive increase in the temperature as, instead, would happen if only the windings 6 were present.

In addition, the contribution of the windings 6 makes it possible to reduce the overall size of the permanent magnets to be installed in the rotor 3, thus reducing the overall manufacturing cost and also facilitates the production thereof since the necessary quantity of materials difficult to obtain on the market is reduced.

The windings 5 are preferably made at least partially of aluminium and/or copper.

In particular, the choice of aluminium has the particular advantage of greatly reducing the cost as much as the overall weight of the windings 5, simplifying the sizing thereof, as well as ensuring an optimal resistance to the centrifugal forces.

The windings 5 are preferably connected in series and arranged so as to define, each one, a corresponding rotor pole or, alternatively, the windings may be grouped together to define, via each group, a corresponding pole.

In particular, the windings 5 arranged inside a group of second slots B create a separate and corresponding rotor pole 3.

Advantageously, the connection of the rotor windings 5 in series enables the rotor to freewheel in the event of a fault (absence of power). This, thanks to the reduced number of magnets used inside a hybrid rotor in accordance with the invention, is possible for the user with maximum safety and with the guarantee that the machine never operates in uncontrolled generator operation (UGO).

Additionally, the motor 1 also comprises a connection plate (or a structurally similar element) applied to one end face of the casing, which is configured to electrically connect the windings 5.

In other words, the motor 1 is equipped at one of the ends of the casing with a connection element configured to electrically connect the windings 5 housed inside the second slots B.

To additionally optimise the result obtained by the synergistic cooperation between permanent magnets 4 and windings 5, it is possible to create second slots B that have a greater volume than that of the first slots A.

This manufacturing solution optimises the relationship of the contributions made, respectively, by the permanent magnets 4 and by the windings 5 to the overall operation of the motor 1.

In accordance with a first possible embodiment, each winding 5 is specifically coupled to a corresponding group of second slots B.

In other words, each individual winding 5 extends between several second distinct slots B, in particular between two second slots B contributing to defining the arms of the same “V” shaped profile or between three second slots B contributing to defining the same “U” shaped profile or, in general, between the second slots B defining the different sections of the segmented profile.

In this context, each winding 5 is wrapped around partitions placed between the second slots B of each group and can, thus, be made using a wire or a cable or elements with a similar configuration that are progressively wound around the partitions until filling the second slots B.

In general, the second slots B may additionally comprise a divider element D placed inside and around which it is possible to wind the winding 5.

In this way, an individual winding made using wire-like elements may also be connected to just one second slot B without the need to wind it inside two or more adjacent second slots B.

In accordance with a possible, alternative embodiment, the windings are made using hairpins or bars or other similar, separate elements inserted inside the second slots B (for example, wire-like elements wrapped inside corresponding second slots B around a suitable divider element D).

In other words, each second slot B is filled by respective, multiple separate and distinct elements that thus define the windings 5.

In accordance with an additional, possible embodiment, the motor 1 comprises a plurality of cartridges 6, which can be made, for example, of ferrosilicon, each of which is configured and shaped to be housed in a corresponding second slot B.

In this context, the windings 5 are wrapped around corresponding cartridges 6, as can be observed, for example, in FIG. 3.

In other words, inside each second slot B, a corresponding cartridge 6 is inserted and each cartridge 6 is wound in a corresponding winding 5 that can, thus, preferably be made using a wire, a cable, or a similarly structured element.

Operationally, the windings 6 are thus placed between the cartridges 6 and the walls or portions of walls of the rotor 3 that define the second slots B.

An insulating layer, specifically electrically insulating, is preferably placed between each cartridge 6 and the corresponding winding 5, so as to keep electrically separate the cartridge 6 that performs the support function and the winding 5.

Advantageously, the motor 1 additionally comprises a dedicated power device specifically configured to supply electric power to the windings 5 of the rotor 3.

Each cartridge 6 preferably comprises a central element provided with a central portion, for winding, arranged between two end portions, with a greater width, coupled in the rotor body.

In other words, the central element 6, preferably made of ferrosilicon, extends along one direction of insertion in the slot (or winding direction) and has a cross-section transverse to said direction basically shaped like an inverted “H”, with the central portion wound and the end portions widened and coupled in the rotor body in special seats external to the volume of the slot.

More precisely, on a plane transverse to the insertion direction, each central element has a narrow portion extending mainly along a first direction and defining the central portion, and two widened portions extending mainly along a second direction orthogonal to the first and arranged on opposite sides to the central portion, defining the end portions.

Once coupled, the end portions are fixed in the corresponding seats in a known way, using glue or mechanical interference.

It should be noted that, preferably, these external seats define undercuts in which the end portions can be/are inserted; advantageously, in this way, the central elements, in addition to having the function of generating the flow, also define mechanical reinforcements of the rotor, increasing the performance and reliability thereof.

In use, the dedicated power device thus makes it possible to finely adjust the rotor field depending on the performance required in terms of efficiency, the thermal profile, and overall safety of the motor 1 and potentially during reconfiguration, if the motor 1 is of the variable configuration type (as will be explored below).

In more detail, this dedicated power device may be advantageously integrated inside an inverter of the motor 1 and be coupled to the windings 5 using a special electrical circuit to provide electric power to it.

In this way, it is possible to modulate the current of the rotor 3 precisely managing the overall performance of the motor 1.

In accordance with an additional aspect of this invention, the motor 1 is a variable configuration motor.

In other words, the motor comprises a plurality of phases, defined, for example, by multiple, electrically conductive elements arranged on the rotor 2, which can be connected according to different electric configurations so as to modify the performance obtained according to the specific use needs.

In this case, the motor 1 additionally comprises a switching device that can be operated so as to vary the operating conditions of the motor 1, adjusting the connections thereof between the phases in order to adapt the operation thereof as needed.

In particular, the switching device can be activated in order to connect the phases together so as to define, at a given moment, at least one of the following configurations between the phases of the stator 2: a triangle configuration, a star configuration, a series configuration, and a parallel configuration.

Advantageously, the motor 1 may comprise more than one switching device in which each of these switching devices is active and interacting with all the phases or with a corresponding group of phases, or is able to connect different groups of phases together, proving, therefore, suitable and configured to define different connections between them, thus allowing the definition and assumption, by the motor 1, of separate configurations.

For example, the motor 1 may comprise a first switching device operating on the phases or on a group of phases so as to switch them between one series configuration and one parallel configuration and a second switching device operating on the phases or on a group of phases so as to switch them between a star configuration and a triangle configuration.

Therefore, there may be two switching devices so that the motor 1 can be switched between the following configurations: a star-parallel configuration, a star-series configuration, a triangle-parallel configuration, and a triangle-series configuration.

Advantageously, this invention achieves the purposes proposed, overcoming the drawbacks complained of in the prior art, providing the user with a motor 1 that maintains high performance levels though limiting its manufacturing cost via a reduction (compared to known devices) in the overall volume of permanent magnets needed and avoiding the need to install complex dedicated power systems.

1. An electric motor comprising:
a stator provided with a casing extending along a main axis between two end faces;
a rotor inserted in said casing that rotates around the main axis, said rotor having a plurality of first slots and a plurality of second slots, said second slots being radially internal in relation to the first slots;
a plurality of permanent magnets inserted in respective first slots;
a plurality of windings coupled to said second slots;
said first slots being grouped together in a plurality of first groups in which each first slot of the same first group defines a corresponding section of a segmented profile, preferably a basically V or U-shaped profile that has a base turned towards said main axis,
characterised in that the second slots are grouped in a plurality of second groups in which each second slot of the same second group defines a corresponding section of a segmented profile, preferably a basically V or U-shaped profile that has a base turned towards said main axis
and in that each winding is connected to a respective rotor pole, said windings being connected together in series.

2. The motor according to claim 1, wherein the second slots have a greater volume than said first slots.

3. The motor according to claim 1, wherein the windings are at least partially made of aluminium and/or copper.

4. The motor according to claim 1, comprising a connection plate applied to an end face of the casing and configured to electrically connect the windings.

5. The motor according to claim 1 in which each winding is coupled to a corresponding pair of second slots, said winding being wound around a partition placed between the second slots of the corresponding pair.

6. The motor according to claim 1, wherein said windings are made using hairpins, bars, or standard wire arranged in said second slots.

7. The motor according to claim 1, comprising a plurality of cartridges inserted in corresponding second slots, said windings being wound around corresponding cartridges.

8. The motor according to claim 9, comprising an insulating layer placed between each cartridge and the respective winding.

9. The motor according to claim 7, wherein each cartridge comprises a central element provided with a central, winding, portion arranged between two end portions, with a greater width, coupled in a rotor body.

10. The motor according to claim 9, wherein the central element:
is made of ferrosilicon;
extends along one direction of insertion in the slot;
has a transverse section in said direction basically shaped like an inverted “H”, with the central portion would and the end portions widened and coupled in the rotor body in special seats external to the volume of the slot.

11. The motor according to claim 1, comprising a plurality of phases and a switching device that can be activated to change an electric configuration of said motor by connecting a plurality of phases in at least one of the following configurations: a triangle configuration, a star configuration, a series configuration, a parallel configuration; the motor preferably comprises two switching devices configured to switch the motor between the following configurations: a star-parallel configuration, a star-series configuration, a triangle-parallel configuration, a triangle-series configuration.

12. The motor according to claim 1, comprising a dedicated power device configured to supply electric power to the windings.
